(19) United States
(12) Patent Application Publication
(10) Pub. No.: US 2011/0182801 A1
(43) Pub. Date: Jul. 28, 2011

(54) MULTI-STAGE METHOD FOR THE PRODUCTION OF CHLORINE

(75) Inventors: Leslaw Mleczko, Dormagen (DE); Oliver Felix-Karl Schluter, Leverkusen (DE); Aurel Wolf, Wulfrath (DE); Stepphan Schubert, League City, TX (US)

(73) Assignee: Bayer Technology Services GmbH, Leverkusen (DE)

(21) Appl. No.: 13/119,098

(22) PCT Filed: Oct. 1, 2009
(86) PCT No.: PCT/EP2009/007040

§ 371 Date: Mar. 15, 2011

(30) Foreign Application Priority Data
Oct. 9, 2008 (DE) 10 2008 050 975.2

(51) Int. Cl. C01B 7/04

(52) U.S. Cl. 423/502

(57) ABSTRACT

The present invention relates to a multistage process for preparing chlorine by catalytic gas phase oxidation of hydrogen chloride with oxygen, in which the conversion is performed over at least two different catalyst beds under adiabatic conditions, and to a reactor system for performing the process.

The present invention relates to a multistage process for preparing chlorine by catalytic gas phase oxidation of hydrogen chloride with oxygen, in which the conversion is performed over at least two different catalyst beds under adiabatic conditions, and to a reactor system for performing the process.

Virtually all of the industrial production of chlorine is accomplished nowadays by electrolysis of aqueous sodium chloride solutions.

However, a significant disadvantage of such chloralkali electrolysis processes is that not only the desired chlorine reaction product but also sodium hydroxide solution is obtained in a large amount. Thus, the amount of sodium hydroxide solution produced is coupled directly to the amount of chlorine produced. However, the demand for sodium hydroxide solution is not coupled to the demand for chlorine, and so, especially in the recent past, the sales revenues for this by-product have declined significantly.

In process technology terms, this means that, in such chloralkali electrolysis processes, energy is present bound within a product, but there is not a sufficient degree of compensation for the expenditure of this energy.

An alternative to such processes is offered by the “Deacon process” developed as early as 1868 by Deacon and named after him, in which chlorine is formed by heterogeneously catalytic oxidation of hydrogen chloride with simultaneous formation of water. The significant advantage of this process is that it is decoupled from the preparation of sodium hydroxide solution. Furthermore, the hydrogen chloride precursor is simple to obtain; it is obtained in large amounts, for example, in phosgenation reactions, for instance in isocyanate preparation, in which the chlorine produced is again preferably used via the phosgene intermediate.

It has already been found that heterogeneous catalysts comprising ruthenium are preferable for use for the abovementioned “Deacon process”. For instance, DE 1 567 788 discloses a catalyst material comprising RuCl₃ on a support material which may comprise aluminium oxide or other ceramic materials. The temperatures at which this process for preparing chlorine is performable with preference are disclosed with ranges from 250 to 500° C.

It is, however, common knowledge that the heterogeneously catalytic reaction of hydrogen chloride with oxygen to give chlorine and water is an exothermic reaction, which subjects the process gas to a temperature rise in the course of the reaction.

Although this temperature rise leads to an entirely desirable increase in the reaction rate according to the commonly known principles of chemical process technology, it is not without reason that DE 1 567 788 specifies a temperature range of up to not more than 500° C. for performance of the process, since the said catalysts comprising ruthenium have the desired high activity for catalysis of the reaction of hydrogen chloride to give chlorine only up to a maximum of those temperatures.

In general, higher temperatures bring about sintering of such catalysts comprising ruthenium or lead to oxidation to give volatile ruthenium tetroxide. Accordingly the removal and use of the heat of reaction is essential for the performance of the “Deacon process” using such preferred catalysts. However, DE 1 567 788 does not disclose any features that would enable such temperature control.

Against this background, WO 2004/052776 discloses a process performed in a tube bundle reactor whose temperature is controlled by means of heat carrier medium and which is filled with catalyst material. The tube bundle reactors disclosed are intended to ensure a high heat transfer surface area in order to prevent the formation of “hotspots”, which can in turn result in damage to the catalyst in the abovementioned form.

The process and the apparatus of WO 2004/052776 are, however, disadvantageous because the desired temperature control is ensured by a maximum number of tubes (>10 000), which leads to very complex design embodiments of the apparatus in which the process is performable. Such complex design embodiments lead inevitably to high capital costs and, particularly in the case of large reactors, to very complex apparatus in the periphery of the reaction apparatus; in this case, especially in relation to the apparatus for cooling the reaction apparatus. In addition, the problems with regard to mechanical strength and homogeneous thermostating of the catalyst bed rise with the necessary size of such apparatus.

An alternative to the solution to the abovementioned problems, which is complex in terms of apparatus, relates to the catalysts comprising ruthenium, disclosed, for instance, by EP 1 170 250. Here, excessively high temperatures in the region of the reaction zones are counteracted by using catalyst beds adjusted to the reaction profile, having reduced activity of the catalyst comprising ruthenium. Such adjusted catalyst beds are achieved, for example, by “diluting” the catalyst beds with inert material, or by simply creating reaction zones with a lower proportion of catalysts comprising ruthenium.

The process disclosed in EP 170 250 is, however, disadvantageous, since such a “dilution” creates reaction zones with a desirably low space-time yield. However, this is at the expense of the economically viable operation of the process, since the reaction zones, which are highly diluted with inert material especially at the start of the process, first have to be heated to the operating temperatures. Energy is expended for this purpose, in order to also heat the inert material which is actually not required for performance of the reaction. The reaction apparatus to be provided according to the disclosure of EP 1 170 250 is also not least larger and hence more expensive than would be required, since additional space has to be created to accommodate the inert material.

A further development of processes for heterogeneously catalytic oxidation of hydrogen chloride with oxygen to give chlorine is disclosed in WO 2007/134771. According to WO 2007/134771, the process is performed in at least two adiabatic reaction zones, which results in a simple design configuration and, as a result, in low costs for the reaction apparatus including its periphery.

The process disclosed in WO 2007/134771 is, however, disadvantageous in that, owing to the catalysts used according to the disclosure, comprising ruthenium oxide, ruthenium chloride, ruthenium oxychloride, rhodium oxide, copper chloride, copper oxide, chromium oxide, bismuth oxide, etc., it is reliant on exact compliance with the operating temperature of up to 400° C. for the reasons mentioned above. It is therefore further disclosed that the reaction is performed in more than two reaction zones with cooling between the individual reaction zones. Compliance with this limit is also established by controlled selection of the reaction conditions (inlet temperature, gas composition, catalyst type, etc.), which is likewise complex and therefore disadvantageous at least economically.

DE 1 078 100 discloses that uranium-containing catalysts are also usable for the heterogeneously catalytic oxidation of hydrogen chloride to chlorine. DE 1 078 100 further discloses that such a process for heterogeneously catalysed oxidation of hydrogen chloride to chlorine is performable at temperatures of up to 480° C.

DE 1 078 100 does not disclose whether and to what extent such processes are performable in an integrated system with other process variants using catalysts comprising ruthenium. The maximum achievable conversion of the process disclosed in DE 1 078 100 is 62%, which is low and thus disadvantageous measured by the conversions possible according to the disclosures cited above.

Proceeding from the prior art, there is thus still the need to provide a process for heterogeneously catalytic oxidation of hydrogen chloride to chlorine, which can be operated at least partly within a wider temperature range without the risk of lasting damage to the catalyst material used, and which is economically advantageous over the known processes at least as a result of the reduced need for apparatus complexity.

It has now been found that, surprisingly, a process for heterogeneously catalytic oxidation of hydrogen chloride in a process gas in at least one reaction stage comprising two adiabatic reaction zones in series, which is characterized in that a catalyst present in the second reaction zone of the at least one reaction stage comprises a uranium component, and in that this second reaction zone is operated at temperatures of 350° C. to 800° C., can achieve this object.

In connection with the present invention, process gas means a gas mixture at least comprising oxygen and hydrogen chloride. Process gases may also comprise secondary constituents, and the chlorine and water reaction products. Nonexclusive examples of such secondary constituents are, for instance, nitrogen, carbon dioxide or carbon monoxide.

Oxygen may be pure oxygen or preferably an oxygen-containing gas, especially air.

The hydrogen chloride of the process gas may originate from other processes, for instance for preparing polyisocyanates, and comprise further impurities, for instance phosgene and organic components. Thus, nonexclusive examples of the aforementioned organic components are, for instance, the residues of solvents originating from such processes, for instance chlorobenzene. The chlorine produced can be used, for example, to prepare phosgene and can optionally be recycled into associated production processes.

According to the invention, an adiabatic reaction zone means that heat is essentially neither supplied to nor withdrawn from the reaction zone from outside. “Essentially” means here more particularly that the person skilled in the art is aware that a completely adiabatic reaction zone is known to the person skilled in the art as a thermodynamic limiting case, the implementation of which is, however, impossible. Moreover, heat can be supplied or removed by entering or exiting reaction gas. However, no additional measures are taken from the outside to cool/heat the reaction zones. In technical terms, this is possible through insulation of the reaction zones in a manner known per se.

The advantages of the inventive adiabatic operating mode of the reaction zones over the other operating modes are in principle that no means of heat removal need be provided in the reaction zones, which entails a considerable simplification of the construction. As a result, simplifications in particular arise in the construction of the reaction apparatus, and in the scalability of the process.

The process according to the invention, and the preferred variants and developments thereof described hereinafter, can be operated continuously or batchwise. Preference is given, however, to operating the process continuously.

All variants are described hereinafter with the assumption of a continuous operating mode. However, it is immediately possible for a person skilled in the art, proceeding from this, to modify the process according to the invention and the apparatus needed for operation thereof to such an extent that parts or the entire process can be operated in batchwise mode.

The catalyst present in the first, adiabatically operated reaction zone of the at least one reaction stage may be a catalyst as also already known from the prior art described in this document.

The catalyst in this first, adiabatically operated reaction zone is preferably used immobilized on a support. The catalyst in the first, adiabatically operated reaction zone of the at least one reaction stage preferably comprises at least one of the elements selected from the list comprising copper, potassium, sodium, chromium, cerium, gold, bismuth, ruthenium, rhodium, platinum, and the elements of transition group VIII of the periodic table of the elements. These are preferably used in the form of oxides, halides or mixed oxides/halides, especially chlorides or oxides/chlorides. These elements or compounds thereof can be used alone or in any desired combination.

Preferred compounds of these elements include: copper chloride, copper oxide, potassium chloride, sodium chloride, chromium oxide, bismuth oxide, ruthenium oxide, ruthenium chloride, ruthenium oxychloride, rhodium oxide.

The catalyst in the first, adiabatically operated reaction zone of the at least one reaction stage more preferably consists completely or partially of ruthenium or compounds thereof. The catalyst in this first, adiabatically operated reaction zone more preferably consists of halide and/or oxygen-containing ruthenium compounds.

The support of the catalyst in the first, adiabatically operated reaction zone of the at least one reaction stage may completely or partly consist of: titanium oxide, tin oxide, aluminium oxide, zirconium oxide, vanadium oxide, silicon oxide, carbon nanotubes or a mixture or compound of the substances mentioned, such as especially mixed oxides such as silicon-aluminium oxides. Particularly preferred support materials are tin oxide, aluminium oxide and carbon nanotubes.

The catalyst in the first reaction zone of the at least one reaction stage may also be doped with a promoter material. When the catalyst is doped, suitable promoters are alkali metals such as lithium, sodium, potassium, rubidium and caesium, preferably lithium, sodium and potassium, more preferably potassium, alkaline earth metals such as magnesium, calcium, strontium and barium, preferably barium and calcium, more preferably barium, rare earth metals such as scandium, yttrium, lanthanum, cerium, samarium, gadolinium, lutetium, praseodymium and neodymium, preferably scandium, yttrium, lanthanum and cerium, more preferably lanthanum and cerium or mixtures thereof.

The catalysts specified here in the first, adiabatically operated reaction zone of the first reaction stage are particularly advantageous since, even at relatively low temperatures, they have a high activity for the oxidation of hydrogen chloride to chlorine.

The catalyst of the second reaction zone of the at least one reaction stage, comprising a uranium component, may or may not comprise a support material.

When a catalyst comprising a uranium component and a support material is used in the second reaction zone of the at least one reaction stage of the process according to the invention, suitable support materials are those selected from the list comprising silicon oxide, aluminium oxide, titanium oxide, tin oxide, zirconium oxide, cerium oxide or mixtures thereof.

Typically, the proportion of the uranium component in the catalyst when it additionally comprises a support material is in the range from 0.1 to 90% by weight, preferably in the range from 1 to 60% by weight, more preferably in the range from 1 to 50% by weight, based on the total mass of uranium or of the uranium compound and support material.

The use of catalysts comprising a support material is particularly advantageous in order to obtain, more particularly, the beds described hereinafter.

In connection with the present invention, uranium components denote uranium oxides, uranium chlorides and/or uranium oxychlorides. Suitable uranium oxides are UO₃, UO₂, UO, or the uranium oxides of a nonstoichiometric composition. Preferred uranium oxides of nonstoichiometric composition are those selected from the list comprising U₃O₅, U₂O₅, U₃O₇, U₃O₈ and U₄O₉. Preference is given to uranium oxides or mixtures of uranium oxides with a stoichiometric composition from UO_{2.1} to UO₅.

In connection with the present invention, uranium oxychlorides denote substances of the general composition UOₓCl_{y}, where x and y are each natural numbers greater than zero. Uranium oxychlorides thus also denote nonstoichiometric compositions comprising chlorine, oxygen and uranium.

In a preferred development of the process according to the invention, the catalyst used in the second reaction zone of the at least one reaction stage comprises only one support selected from the above list and a uranium compound and/or uranium. The catalyst used more preferably comprises only a uranium compound or uranium.

Such catalysts are particularly advantageous because it has been found that, surprisingly, such catalysts also still catalyse the oxidation of hydrogen chloride to chlorine when the temperatures of the process gas at the inlet to the second reaction zone exceed a value which makes the economic and in particular continuous use of catalysts as used in the first reaction zone appear doubtful.

More particularly, it has been found that, surprisingly, these catalysts do not tend to undergo sintering or oxidation to volatile compounds at the elevated temperatures in the second reaction zone.

Thus, the process is particularly advantageous because the reaction can be performed in at least one reaction stage in two successive adiabatic reaction zones without the need for a complex cooling or “dilution” of catalyst material. In this context, it is also particularly advantageous that the adiabatic operation of the first reaction zone allows, for the first time, the energy of the reaction in the second, adiabatic reaction zone of the at least one reaction stage to be utilized in a particularly advantageous manner.

The catalysts in the reaction zones of the reaction stages may be present in various forms. Nonexclusive examples of such forms in which the catalysts in the reaction zones of the reaction stages may be present are, for instance, the forms commonly known to those skilled in the art of the fixed bed, moving bed or fluidized bed.

Preference is given to a fixed bed arrangement. This comprises a bed of the catalyst and packings of the catalyst.

The term “bed of the catalyst” as used here also includes continuous regions of suitable packings on a support material or structured catalyst supports.

In principle, the catalysts may have any desired form, for example spheres, rods, Raschig rings, granules or tablets.

Alternative forms would be, for instance, coated ceramic honeycomb supports with comparatively high geometric surface areas or corrugated layers of metal wire fabric on which, for example, catalyst granules are immobilized.

The process according to the invention is performable in a simple manner also in apparatus as already in operation. It is merely necessary to provide a second reaction zone by filling parts of the reaction apparatus with the catalyst comprising a uranium component. There is no need for a costly conversion.

The reactors used with preference in the process according to the invention may thus likewise consist of simple vessels with one or more thermally insulated catalyst beds, as described, for example, in Ullmanns Encyclopedia of Industrial Chemistry (Fifth, Completely Revised Edition, Vol B4, pages 95-104, pages 210-216). In other words, they may, for example, be simple or multistage fixed bed reactors, radial-flow reactors or else shallow-bed reactors. Tube bundle reactors are, however, preferably not used owing to the disadvantages described above. Since, according to the invention, there is no removal of heat from the catalyst beds, such reactor types for the accommodation of the catalyst beds are also dispensable.

The catalysts or the catalyst beds thereof are mounted in a manner known per se on or between gas-pervious walls of the reactor in the reaction stages or reaction zones. Especially in the case of thin catalyst beds, engineering devices for homogeneous gas distribution are mounted above, below or above and below the catalyst beds. These may be perforated plates, bubble-cap trays, valve trays or other internals, which bring about homogeneous entry of the gas into the catalyst bed by generating a low but homogeneous pressure drop.

The superficial velocity of the process gas in a reaction zone is, in the case of the embodiment as a fixed bed, preferably between 0.1 and 10 m/s.

The process according to the invention is operated in such a way that temperatures of 350° C. to 800° C. are present in the second reaction zone of the at least one reaction stage, preferably temperatures of 350° C. to 700° C., more preferably temperatures of 350° C. to 600° C.

Owing to the adiabatic operation of the first reaction zone of the at least one reaction stage, and the fact that the catalysts used herein may have adverse properties at excessively high temperatures and that the catalysts of the second reaction zone of the at least one reaction stage do not have these adverse properties, the first reaction zone of the at least one reaction stage is thus preferably operated in such a way that, as a result of the heating of the process gas by the exothermic oxidation of hydrogen chloride to chlorine, it has a temperature of at least 350° C. at the outlet of the first reaction zone.

The methods with which such a temperature can be established at the outlet of the first reaction zone of the at least one reaction stage are common knowledge. Nonexclusive examples are, for instance, the regulation of the composition of the process gas at the inlet of the first reaction zone or the establishment of a defined residence time in the first reaction zone. For example, the abovementioned regulation of the composition of the process gas at the inlet to the first reaction zone of the reaction stage, for example by means of reduced metered addition of hydrogen chloride, allows any temperature increase in the first reaction zone to be averted in a simple manner. Alternatively, a general increase in the volume flow of process gas can reduce the residence time, hence likewise reduce the conversion, and as a result avert the temperature increase in a simple manner. Alternatively, it is also possible to achieve a further reduction in the temperature increase by an increase in the proportion of inert gas in the process gas stream.

Preference is given to establishing a particular exit temperature from the first reaction zone of the reaction stage by a combination of the two aforementioned methods.

Such a mode of operation of the process according to the invention is particularly advantageous because this allows the heat which arises during the reaction to be utilized in an effective manner.

In particular, the necessity of cooling downstream of the first reaction zone of an inventive reaction stage is eliminated.

In general, the first reaction zone of an inventive reaction stage is therefore operated such that, at the inlet thereof, the process gas has a temperature of 150 to 400° C., preferably of 200 to 370° C., more preferably of 250 to 350° C.

The aforementioned temperatures have been found to be advantageous because, at these temperatures, the catalysts of the first reaction zone of an inventive reaction stage still have sufficient activity and do not have excessively marked adverse properties, but the catalysts of the second reaction zone of the inventive reaction stage already possess a high activity.

The process according to the invention and the preferred developments thereof described hereinafter are preferably operated at a pressure of 1 to 30 bar, preferably of 1 to 20 bar, more preferably of 1 to 15 bar, in the reaction zones of the reaction stages.

In a particular embodiment of the process according to the invention, preference is given to using a molar ratio of between 0.25 and 10 equivalents of oxygen per equivalent of hydrogen chloride before entry into the first reaction zone of the at least one reaction stage.

In a preferred development of the process according to the invention, the process comprises more than one inventive reaction stage with the two above-described inventive reaction zones.

In this preferred development of the process according to the invention, heat exchange zones in which the temperature of the process gas originating from the preceding reaction stage are preferably provided between the reaction stages. More preferably, the process gas is cooled in these heat exchange zones to temperatures less than 350° C.

The heat exchange zone may be configured in forms of heat exchangers which are common knowledge to those skilled in the art. These may, for example, be tube bundle, plate, annular groove, spiral, ribbed tube or micro heat exchangers.

In the heat exchange zone, in an alternative embodiment of the preferred development, steam may be raised.

Such raising of steam may be performed, for instance, by first cooling the process gas stream in a heat exchanger of the type described above by means of an industrial heat carrier medium, for example heat carrier oils or high-temperature salt melts, which heats the heat carrier medium.

The heated heat carrier medium can then be fed to a further heat exchanger of the type described above, in which steam is raised as the heat carrier medium is cooled. Preference is given, however, to raising the steam directly in the heat exchange zone as the process gas stream is cooled.

Preference is given to using heat exchangers in which the product gas and the steam are separated from one another by a double wall (so-called double-tube safety heat transferrers). A test gas can flow through the gap between the two walls to monitor for leaks. Such a heat exchanger is preferably a double-tube safety heat transferrer as described, for example, in DE 199 59 467.

Such double-tube safety heat transferrers are particularly advantageous because they allow, in a simple and reliable manner, steam to be generated actually in the course of the process without the need for use of an additional heat carrier fluid (e.g. salt melts, etc.).

The preferred development is particularly advantageous because it allows the process according to the invention to be performed more than once in succession, and the conversion of the process can thus be enhanced virtually as desired up to the thermodynamic equilibrium which prevails at the appropriate temperature.

The particularly preferred temperatures of the preferred development are particularly advantageous because they prevent damage to the catalyst in the first reaction zone of the downstream reaction stage.

In a further preferred development of the process according to the invention, at least one further reaction stage with only one reaction zone is present downstream of the at least one inventive reaction stage, said at least one further reaction stage comprising an inventive second reaction zone, and a heat exchange zone as has already been described in connection with the first preferred development being present upstream of said further reaction stage comprising an inventive second reaction zone.

In this heat exchange zone, the process gas is preferably cooled to temperatures less than 600° C., more preferably to temperatures less than 350° C.

This development of the invention is particularly advantageous because it provides a series of second inventive reaction zones with intermediate cooling, in which the oxidation of hydrogen chloride to chlorine can be accomplished at particularly high temperatures. This enables a particularly high reaction rate, which in turn results in a high space-time yield. Moreover, it is possible here to dispense with the more expensive catalysts of the first inventive reaction zone in favour of the catalysts comprising a uranium component, which were obtainable less expensively at the time of the invention, in the second inventive reaction zone.

In a third preferred development of the process according to the invention, at least one low-temperature reaction stage with only one reaction zone is present downstream of the at least one inventive reaction stage, said at least one further low-temperature reaction stage comprising an inventive first reaction zone, and a heat exchange zone as has already been described in connection with the first preferred development being present upstream of said low-temperature reaction stage comprising an inventive first reaction zone.

In the heat exchange zone according to the third preferred development of the process according to the invention, the process gas is more preferably cooled to temperatures less than 350° C.

This third preferred development of the process according to the invention is particularly advantageous because the equilibrium of the process gas comprising hydrogen chloride and chlorine shifts disadvantageously toward the size of hydrogen chloride at excessively high temperatures, such that a final oxidation of hydrogen chloride to chlorine may nevertheless be enabled by virtue of the limitation of equilibrium achieved, which further improves the space-time yield of the process.

Within the aforementioned preferred development, the further preferred development and the third preferred development, it is possible in an alternative embodiment of the process to feed in a portion of the process gas, which would otherwise only be fed to the first inventive reaction stage, downstream of the first reaction stage but upstream of at least one of the inventive further and/or low-temperature reaction stages which follow thereafter.

In the simplest embodiment of this alternative embodiment, the process would thus comprise two reaction stages, between which there is a heat exchange zone and in which, downstream and/or upstream of the heat exchange zone, a proportion of the process gas, which would otherwise be fed completely and exclusively to the first reaction stage, is fed directly to the second reaction stage.

The division into the individual reaction stages present in the process can be executed either in equal proportions, or else in different proportions, rising or falling from reaction stage to reaction stage, of the overall process gas stream which is fed to the process. Preferably, in this alternative embodiment, a portion of the process gas stream is fed to the reaction stages in falling proportions.

One version of the process according to the alternative embodiment is particularly advantageous because a distributed limited addition of a portion of the process gas stream allows the release of heat and hence the temperature rise in the individual reactor stages to be controlled easily. More particularly, uncontrolled overheating of individual reaction stages and/or reaction zones is impossible, since the exothermic reaction, for the lack of availability of a portion of the process gas stream, for example hydrogen chloride, inevitably stops after the conversion thereof. Only with the metered addition upstream of the next reaction stage is there then any further conversion.

Moreover, by means of the process gas stream which is then composed of the process gas stream from the preceding reaction stage and the further proportion of the process gas stream, the temperature can be adjusted once more by, for instance, supplying the further proportion of the process gas stream at a lower temperature. This reduces the need for cooling in the heat exchange zones, which can be economically advantageous.

In a particularly preferred development of the process according to the invention, the aforementioned low-temperature reaction stage is the last reaction stage of the process and is preceded upstream by more than one inventive reaction stage or one inventive reaction stage and at least one further reaction stage according to the further preferred development.

In a last preferred development of the process according to the invention, the chlorine formed and/or the hydrogen chloride and/or the oxygen is/are removed from the process gas in a separating zone.

The removal in such a removal zone typically comprises several stages, specifically the removal and optional recycling of unconverted hydrogen chloride from the process gas, the drying of the residual stream obtained, which comprises essentially chlorine and oxygen, and the removal of chlorine from the dried residual stream.

The removal can be effected by methods which are common knowledge to those skilled in the art, for instance by condensing aqueous hydrochloric acid out of the process gas. Alternatively, the hydrogen chloride present in the process gas can also be absorbed in dilute hydrochloric acid or water.

In an alternative embodiment of the last preferred development of the process, the oxygen and optionally also hydrogen chloride removed are fed back to at least one of the reaction stages.

In this case, it may be appropriate to conduct the oxygen and any hydrogen chloride removed through a heat exchange zone before passing them into at least one of the reaction stages, in order to bring the oxygen and any hydrogen chloride back to the desired temperature at the inlet to the reaction stage.

Within this alternative embodiment of the last preferred development, it is preferred to pass the oxygen and any hydrogen chloride removed to a heat exchange zone in the form of a heat exchanger in countercurrent to the process gases to be cooled between the reaction stages.

This is particularly advantageous because this allows the heat to be used again directly in the process, without any need to expend additional energy for the cooling or heating of process gases and/or hydrogen chloride.

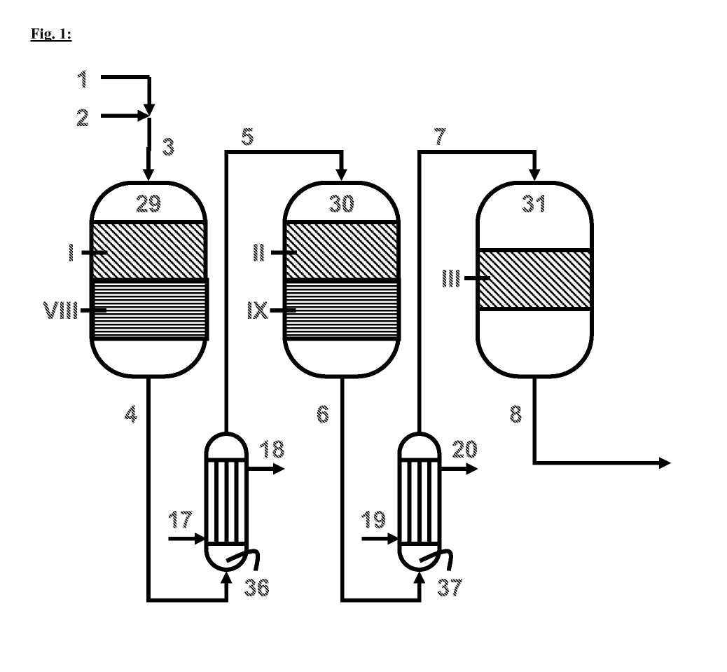

Preferred working examples of the process according to the invention are shown in FIGS. 1 to 4, without the invention being limited thereto.

FIG. 1 shows a process flow diagram for the process according to Example 3. A hydrogen chloride stream (1) and a gas stream comprising oxygen and nitrogen (2) are combined to give the process gas stream (3), which is fed to a reactor (29) in which a reaction stage comprising a fixed bed of a ruthenium catalyst (I) and of a uranium catalyst (VIII) is present. The stream of the process gas (4) is then fed to a heat exchanger (36), and fed as a cooled process gas stream (5) to a further reactor (30) in which there is a reaction stage comprising a fixed bed of a ruthenium catalyst (II) and of a uranium catalyst (IX), for further oxidation of hydrogen chloride to chlorine. The exit stream of the process gas (6) is fed again to a heat exchanger (37) and, as a recooled stream of the process gas (7), enters a last reactor (31) in which there is a fixed bed of a ruthenium catalyst (III). The process gas stream (8) at the outlet of the reactor (31) constitutes the process product.

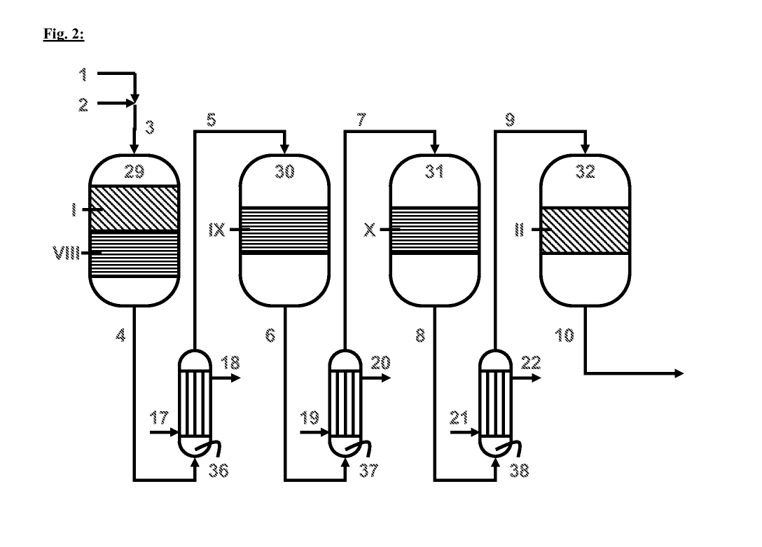

FIG. 2 shows a process flow diagram for the process according to Example 4. A hydrogen chloride stream (1) and a gas stream comprising oxygen and nitrogen (2) are combined to form the process gas stream (3) which is fed to a reactor (29) in which there is a reaction stage comprising a fixed bed of a ruthenium catalyst (I) and of a uranium catalyst (VIII). The stream of the process gas (4) is then fed to a heat exchanger (36), and fed as a cooled process gas stream (5) to a further reactor (30) in which there is a reaction stage comprising a fixed bed of uranium catalyst (IX) for further oxidation of hydrogen chloride to chlorine. The exit stream of the process gas (6) is fed again to a heat exchanger (37) and, as a recooled stream of the process gas (7), enters a further reactor (31) in which there is a reaction stage comprising a fixed bed of a uranium catalyst (X). The process gas stream (8) at the outlet of the reactor (31) in turn enters a heat exchanger (38) and, as a stream of the process gas (9) which has been cooled again, enters a last reactor (32) in which there is a fixed bed of a ruthenium catalyst (II). The process gas stream (10) at the outlet of the reactor (32) constitutes the process product.

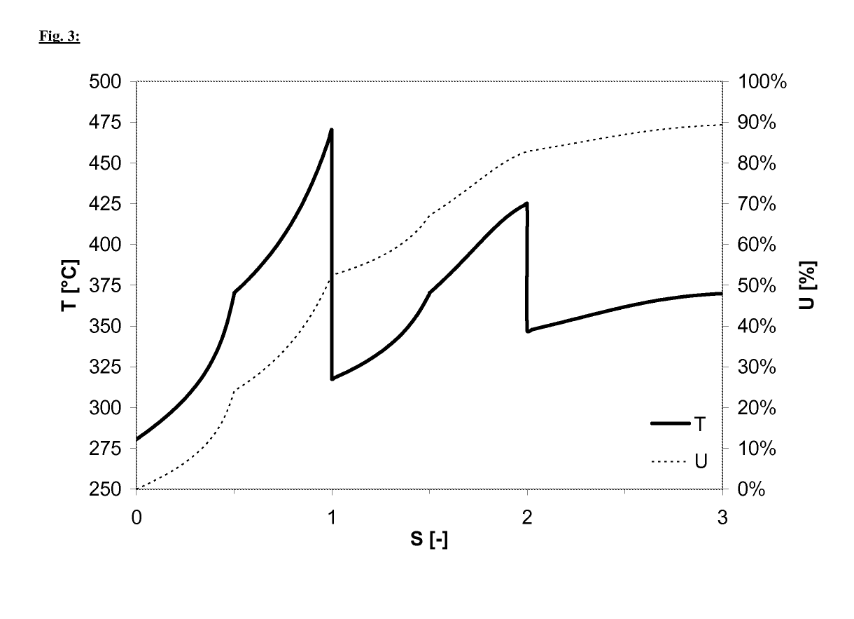

FIG. 3 shows the profile of conversion of hydrogen chloride and the temperature in the course of the process over the individual reaction stages (S) according to Example 3. The temperature (T) of the process gas is plotted against the left-hand Y-axis as a thick continuous line, and the conversion (U) of hydrogen chloride against the right-hand Y-axis as a thin broken line.

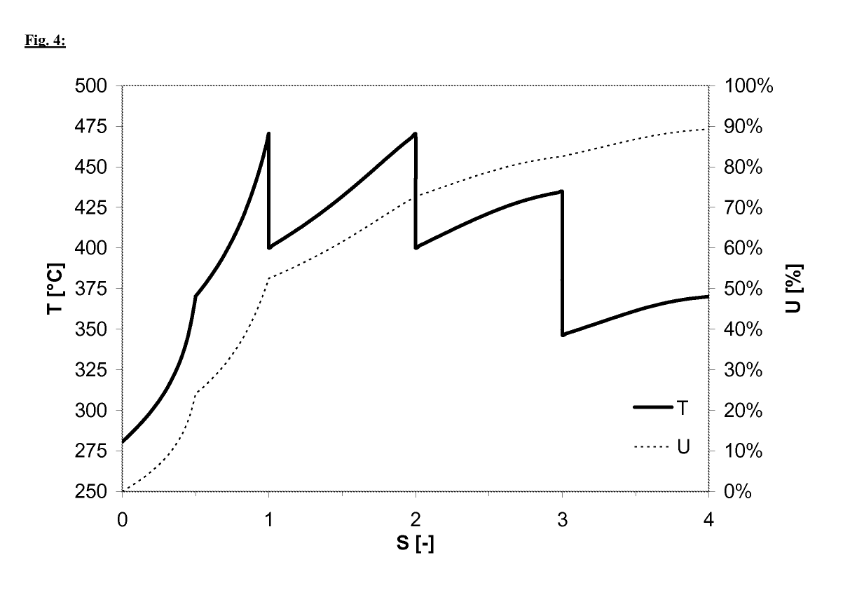

FIG. 4 shows the profile of conversion of hydrogen chloride and the temperature in the course of the process over the individual reaction stages (S) according to Example 4. The temperature (T) of the process gas is plotted against the left-hand Y-axis as a thick continuous line, and the conversion (U) of hydrogen chloride against the right-hand Y-axis as a thin broken line.

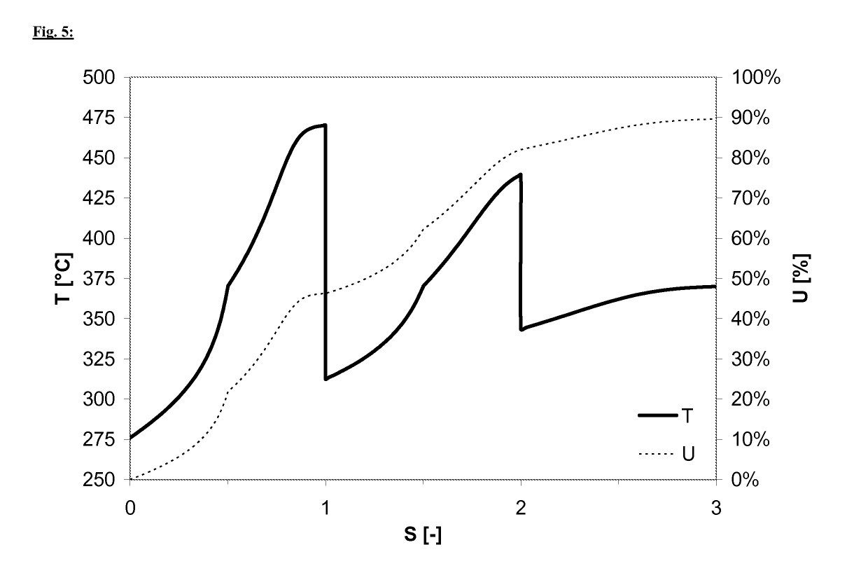

FIG. 5 shows the profile of conversion of hydrogen chloride and the temperature in the course of the process over the individual reaction stages (S) according to Example 5. The temperature (T) of the process gas is plotted against the left-hand Y-axis as a thick continuous line, and the conversion (U) of hydrogen chloride against the right-hand Y-axis as a thin broken line.

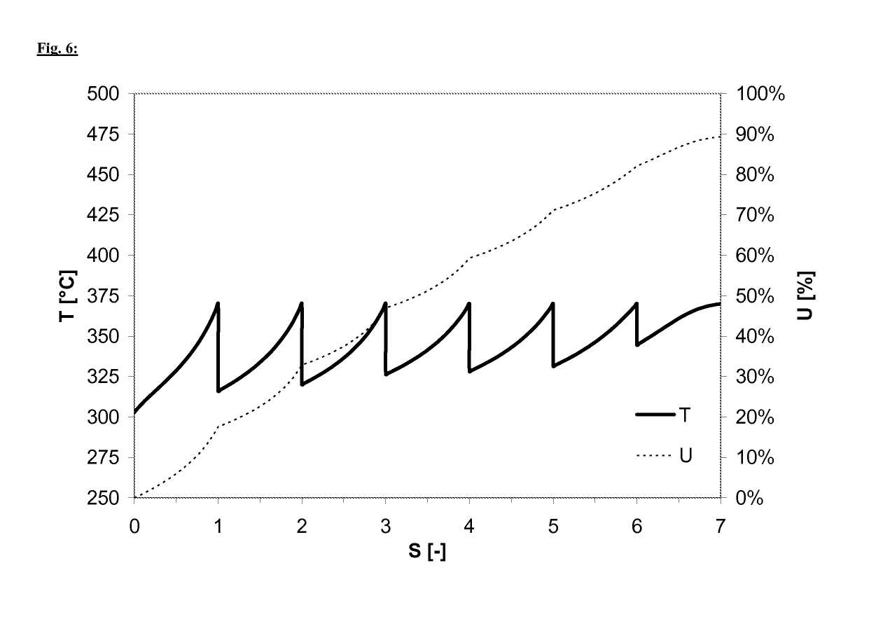

FIG. 6 shows the profile of conversion of hydrogen chloride and the temperature in the course of the process over the individual reaction stages (S) according to Comparative Example 1. The temperature (T) of the process gas is plotted against the left-hand Y-axis as a thick continuous line, and the conversion (U) of hydrogen chloride against the right-hand Y-axis as a thin broken line.

### EXAMPLES

### Example 1

### Preparation of Catalysts

### Preparation of a Uranium Catalyst for Use in the Second Reaction Zone

2 g of a pulverulent uranium(V/VI) oxide (from Strem Chemicals) were dried at 150° C. in a drying cabinet at ambient pressure overnight, and then calcined at 500° C. under air for 2 h.

### Preparation of a Ruthenium Catalyst for Use in the First Reaction Zone

100 g of spherical SnO₂ shaped bodies with an average diameter of 1.9 mm, a BET of 45.1 m²/g and 15% by weight of Al₂O₃ as a binder were impregnated with a solution of 9.99 g of commercial ruthenium chloride n-hydrate (Heraeus GmbH). After an impregnation time of 1 h, the solid was dried at 60° C. in an air stream for 4 hours. Subsequently, the catalyst was calcined at 250° C. for 16 h. The amount of Ru determined by elemental analysis (ICP-OES) was 1.9% by weight.

### Example 2

### Properties of the Catalysts According to Example 1 in the Oxidation of Hydrogen Chloride

The catalysts from Example 1 were crushed to a mean particle size of approx. 100 μm with a manual mortar in the same way and, in a fixed bed in a quartz reaction tube (internal diameter 10 mm) at 540° C., a gas mixture of 80 ml/min of hydrogen chloride and 80 ml/min (STP) of oxygen was flowed through them.

The quartz reaction tube was heated by an electrically heated fluidized sand bed. At time intervals according to Table 1, the process gas stream was passed into 16% potassium iodide solution for 10 min. The iodine formed was subsequently back-titrated with 0.1 N standard thiosulfate solution in order to determine the amount of chlorine present in the process gas. Table 1 shows the results from the experiment.

| | Activity of the | Activity of the |
|---|---|---|
| Time | uranium catalyst | ruthenium catalyst |
| [h] | [kg Cl₂/kg_{catalyst}*h] | [kg Cl₂/kg_{catalyst}*h] |
| 2 | 3.8 | 27.1 |
| 10 | 3.7 | 24.2 |
| 39 | 4.3 | 18.8 |
| 68 | 4.5 | 12.9 |

Table 1 shows that the ruthenium catalyst is notable for a significant decline in activity under the conditions of the process, whereas the activity of the uranium catalyst for oxidation of hydrogen chloride to chlorine has even increased after 68 h. It is possible to extrapolate in a simple manner that further-increased temperatures and prolonged times would lead to the activity of the ruthenium catalyst falling below that of the uranium catalyst.

### Example 3

### Process Comprising Two Inventive Reaction Stages and One Low-Temperature Reaction Stage

Two inventive reaction stages with two reaction zones each, arranged in succession in a fixed bed reactor, for oxidation of hydrogen chloride to chlorine are used. The inventive reaction stages comprise, as the first reaction zone, a fixed bed of the ruthenium catalyst according to Example 1 and, as the second reaction zone, a fixed bed of a uranium catalyst according to Example 1. Downstream of the two inventive reaction stages is a low-temperature reaction stage which comprises only one reaction zone comprising the ruthenium catalyst according to Example 1.

The residence time of the process gas in the first reaction stage is a total of about 2.3 s, the residence time in the first reaction zone of the first reaction stage being about 0.9 s and the residence time in the second reaction zone of the first reaction stage about 1.4 s.

The residence time in the second reaction stage is a total of about 3.5 s, the residence time in the first reaction zone of the second reaction stage being about 0.9 s and the residence time in the second reaction zone of the second reaction stage about 2.6 s.

The residence time in the low-temperature reaction stage is about 0.7 s.

Between the first and second reaction stages, and second and third reaction stages, there is a tube bundle heat exchanger in which the process gases are cooled to about 350° C.

The process gas at the inlet of the first reaction stage is composed of hydrogen chloride, oxygen and nitrogen in a relative molar ratio of 4:4:2. The process gas is fed only to the first reaction stage and withdrawn at the outlet of the third reaction stage.

FIG. 3 shows the profile of the temperature of the process gas in the process, and the conversion in the course of the process.

It is evident that, under the conditions described above, the process gas at the outlet of the first reaction zone in each case of the inventive reaction stages has a temperature of about 370° C. In the second reaction zone in each case of the inventive reaction stages, the oxidation of hydrogen chloride to chlorine is continued under adiabatic conditions, which increases the temperature in the second reaction zone of the first reaction stage to about 470° C. and that in the second reaction zone of the second reaction stage to about 425° C.

The conversion of hydrogen chloride achieved according to this example in the overall process is 89% at the outlet of the last reaction stage.

It is found that, with only two inventive reaction stages connected in series and one low-temperature reaction stage, a very high conversion can already be achieved. The apparatus complexity required for this purpose is very low. Moreover, the first reaction zones of the inventive reaction stages and of the low-temperature reaction stage are operated at temperatures at which there is a risk at least of relatively low degradation of the activity of the catalyst.

### Example 4

### Process Comprising One Inventive Reaction Stage, Two Reaction Stages According to a Further Preferred Development and One Low-Temperature Reaction Stage

An inventive reaction stage with two reaction zones each, arranged successively in a fixed bed reactor, for oxidation of hydrogen chloride to chlorine is used. The inventive reaction stage comprises, as the first reaction zone, a fixed bed of the ruthenium catalyst according to Example 1 and, as the second reaction zone, a fixed bed of a uranium catalyst according to Example 1. Downstream of the inventive reaction stage, there are two reaction stages according to the further preferred development of the process according to the invention, each comprising a reaction zone comprising the uranium catalyst according to Example 1. Downstream of this, there is a low-temperature reaction stage which comprises only one reaction zone comprising the ruthenium catalyst according to Example 1.

The residence time of the process gas in the first reaction stage is a total of about 2.3 s, the residence time in the first reaction zone of the first reaction stage being about 0.9 s and the residence time in the second reaction zone of the first reaction stage being about 1.4 s.

The residence time in the second reaction stage is about 1.1 s.

The residence time in the third reaction stage is about 1.5 s.

The residence time in the low-temperature reaction stage is about 0.7 s.

Between the reaction stages, there are tube bundle heat exchangers in each case. In the first and second tube bundle heat exchangers, the process gases are cooled to about 400° C. in each case. In the third tube bundle heat exchanger, the process gases are cooled to about 350° C.

The composition of the process gas at the inlet to the first reaction stage corresponds to Example 3.

FIG. 4 shows the profile of the temperature of the process gas in the process, and the conversion in the course of the process.

It is evident that, under the above-described conditions, the process gas at the outlet of the first reaction zone of the inventive first reaction stage has a temperature of about 370° C. In the second reaction zone of the inventive first reaction stage, the oxidation of hydrogen chloride to chlorine is continued under adiabatic conditions, as a result of which the temperature in the second reaction zone of the first reaction stage increases to about 470° C. Thereafter, the process gas is cooled to about 400° C. as described above and heated again in the second reaction stage under adiabatic conditions to 470° C. Upstream of the third reaction stage, the process gas is again cooled to about 400° C. and is heated again under adiabatic conditions in the third reaction stage to about 440° C. The increase is smaller, since only smaller amounts of hydrogen chloride can be oxidized exothermically to chlorine. Upstream of the last reaction stage, the mixture is cooled to about 350° C. and a last oxidation is performed under adiabatic conditions in the low-temperature reaction stage, as a result of which the process gas is heated again to about 370° C.

The conversion of hydrogen chloride achieved according to this example in the overall process is 89% at the outlet of the last reaction stage.

It is found that a very high conversion can likewise be achieved with the process variant described in this example. Moreover, the temperature level at which the cooling is performed in the heat exchangers becomes higher, such that more exergetic energy can be obtained in this case. The apparatus complexity required for this purpose is still comparatively low. Moreover, the first reaction zone of the inventive reaction stage and of the low-temperature reaction stage is operated at temperatures at which there is a risk at least of relatively low degradation of the activity of the catalyst.

### Example 5

### Process with Division of Parts of the Process Gas Between the Reaction Stages

A process identical to that in Example 3 is performed, with the sole difference that 57% by volume of the hydrogen chloride present in the process gas stream are fed in upstream of the first reactor stage, and the remainder of 43% by volume of the hydrogen chloride is fed to the process upstream of the second reaction stage.

The residence time of the process gas in the first reaction stage is a total of about 4.3 s, the residence time in the first reaction zone of the first reaction stage being about 1.2 s and the residence time in the second reaction zone of the first reaction stage being about 3.1 s.

The residence time in the second reaction stage is a total of about 3.7 s, the residence time in the first reaction zone of the second reaction stage being about 1 s and the residence time in the second reaction zone of the second reaction stage being about 2.7 s.

The residence time in the low-temperature reaction stage is about 0.9 s.

FIG. 5 shows the profile of the temperature of the process gas in the process, and the conversion in the course of the process.

It is evident that, under the above-described conditions, the process gas at the outlet of the first reaction zone in each case of the inventive reaction stages has a temperature of about 370° C. In the second reaction zone in each case of the inventive reaction stages, the oxidation of hydrogen chloride to chlorine is continued under adiabatic conditions, as a result of which the temperature in the second reaction zone of the first reaction stage increases to about 470° C., and that in the second reaction zone of the second reaction stage to about 435° C. The latter temperature is higher than in the otherwise analogous Example 3, since more hydrogen chloride is now oxidized to chlorine under adiabatic conditions.

The conversion of hydrogen chloride achieved according to this example in the overall process is likewise 89% at the outlet of the last reaction stage.

It is found that the process with division of portions of the process gas between the reaction stages, especially at the end of the first reaction stage, can stop the reaction in a controlled manner, such that it can be continued at a clearly defined temperature in the second reaction stage with addition of further hydrogen chloride (cf. FIG. 5). This makes the process significantly better controllable and safer. There is no risk of “runaway” of the reaction.

### Comparative Example 1

### Process Comprising Five Reaction Stages Containing Only Reaction Zones Comprising Ruthenium Catalyst

Five reaction stages with reaction zones, each arranged in a fixed bed reactor, comprising the ruthenium catalyst according to Example 1 are used.

Between the reaction stages, there is a tube bundle heat exchanger in each case. In the tube bundle heat exchangers, the process gases are cooled in each case to about 290° C. to 330° C.

The composition of the process gas at the inlet to the first reaction stage corresponds to Example 3.

The residence time of the process gas in the first reaction stage is about 1.1 s, the residence time in the second reaction stage about 1.4 s, that in the third about 1.6 s, that in the fourth about 1.7 s, that in the fifth reaction stage about 1.9 s. Overall, there is thus a residence time of about 7.7 s in this process.

FIG. 6 shows the profile of the temperature of the process gas in the process, and the conversion in the course of the process.

It is evident that, under the above-described conditions, the process gas at the outlet of the first reaction stage has a temperature of about 365° C. Thereafter, the process gas is cooled to about 295° C. and, in the subsequent reaction stage, heated again back to about 365° C. by oxidation of hydrogen chloride to chlorine under adiabatic conditions. The sequence of adiabatic oxidation and cooling continues in an oscillating manner, increasingly higher temperatures being needed in the heat exchangers after the cooling, since, as a result of the advancing oxidation of hydrogen chloride to chlorine, the amount of hydrogen chloride in the process gas decreases over the reaction stages. The decrease in hydrogen chloride in the process gas leads to the reaction approaching the thermodynamic equilibrium; this leads to a decrease in the reaction rate, which has to be compensated for by increasing the temperature level. At the outlet of the fifth and last reaction stage, the approach to the thermodynamic equilibrium is recognized by the turning point and the flattening-out of the evolution of the reaction temperature, and also by the corresponding decrease in the rise of the conversion.

The conversion of hydrogen chloride achieved according to this example in the overall process is about 90% at the outlet of the fifth and last reaction stage.

It is found that, with the process variant described in this comparative example, a conversion similar to the process according to the invention can be achieved, but the number of reaction stages needed for this purpose is higher since, owing to the tendency of the catalyst to be deactivated rapidly at elevated temperatures, the progress of the adiabatic reaction has to be interrupted earlier for cooling, or, in general terms, it is necessary to work at lower temperatures on average than is the case in the process according to the invention.

1. Process for the production of chlorine by the heterogeneous catalytic oxidation of hydrogen chloride in a process gas in at least one reaction stage comprising two adiabatic reaction zones in series, wherein a catalyst present in the second of said two adiabatic reaction zones in said series comprises a uranium component, and this second reaction zone is operated at temperatures of 350° C. to 800° C.

2. Process according to claim 1, wherein the first reaction zone is operated with inlet temperatures of the process gases of 150 to 400° C.

3. Process according to claim 1, wherein the process comprises more than one reaction stage comprising two reaction zones.

4. Process according to, claim 1, wherein heat exchange zones are provided between reaction stages in which the temperature of the process gas from a preceding reaction stage is reduced to temperatures of less than 350° C. before entering a next stage.

5. Process according to any claim 1, wherein at least one further reaction stage with only one reaction zone is present downstream of the at least one reaction stage, said at least one further reaction stage comprising a second reaction zone, and a heat exchange zone being present upstream of said further reaction stage comprising a second reaction zone.

6. Process according to claim 1, wherein at least one further reaction stage, which is a low-temperature reaction stage with only one reaction zone, is present downstream of the at least one reaction stage, said at least one further low-temperature reaction stage comprising a first reaction zone, and a heat exchange zone being present upstream of said low-temperature reaction stage comprising a first reaction zone.

7. Process according to claim 4, wherein the heat exchange zones between the reaction stages are configured in the form of double-tube safety heat transferors, and steam is raised directly therein.

8. Process according to claim 1, comprising more than one reaction stage and wherein a portion of the process gas is fed to the process downstream of the first reaction stage, but upstream of at least one of the reaction stages according to claim 1, further reaction stages according to claim 5 and/or low-temperature reaction stages according to claim 6 which follow thereafter.

9. Process according to claim 1, wherein the chlorine formed and/or hydrogen chloride and/or oxygen is/are removed from the process gas in a separating zone.

10. Process according to claim 9, wherein the oxygen and optionally also hydrogen chloride removed are fed back to at least one of the reaction stages.

11. The process of claim 2, wherein said inlet temperature is 200 to 370° C.

12. The process of claim 10, wherein said inlet temperature is 250 to 350° C.
